(19) United States
(12) Patent Application Publication
(10) Pub. No.: US 2026/0369487 A1
(43) Pub. Date: Nov. 19, 2026

(54) ARC EXTINGUISHING DEVICE

(71) Applicant: LS ELECTRIC CO., LTD., Anyang-si, Gyeonggi-do (KR)

(72) Inventor: Kyu Ho LEE, Anyang-si, Gyeonggi-do (KR)

(21) Appl. No.: 19/139,481

(22) PCT Filed: Dec. 21, 2023
(86) PCT No.: PCT/KR2023/021291

§ 371 Date: Jun. 16, 2025

(30) Foreign Application Priority Data
Jan. 12, 2023 (KR) 10-2023-0004533

(51) Int. Cl. H01H 9/46; H01H 9/30; H01H 9/34; H01H 9/36

(52) U.S. Cl. CPC H01H 9/46; H01H 9/302; H01H 9/345; H01H 9/346; H01H 9/362; H01H 2009/365

(57) ABSTRACT

An arc extinguishing device comprises a grid unit positioned to be close to a fixed and movable contact to extinguish an arc generated when the external fixed and movable contact are spaced from each other; an arc guide coupled to the grid unit to generate gas in response to the generated arc, and which extends in one direction; and an arc runner positioned to be close to the grid unit and arc guide so the generated arc is guided toward the grid unit. The grid unit includes a plurality of first grids having a predetermined height and spaced apart along one direction; and a plurality of second grids positioned close to the plurality of first grids, having a height shorter than the predetermined height, and spaced apart along the one direction. The arc runner is positioned in a space surrounded by the plurality of second and first grids.

### CROSS-REFERENCE TO RELATED APPLICATIONS

This application is a National Stage of International Application No. PCT/KR2023/021291, filed Dec. 21, 2023, which claims priority to and the benefit of Korean Patent Application No. 10-2023-0004533, filed Jan. 12, 2023, the disclosures of which are incorporated herein by reference in its entirety.

### FIELD

The present disclosure relates to an arc extinguishing device, and more particularly, to an arc extinguishing device having a structure capable of effectively extinguishing an arc generated during a breaking operation.

### BACKGROUND

A circuit breaker is installed in a power system and is connected to a power source and a load so as to enable current to flow between them. When an abnormal current occurs between the power source and the load, the circuit breaker performs a breaking operation to interrupt the current flow between the power source and the load. Accordingly, the power source and the load may be protected from damage caused by the abnormal current.

Typically, a circuit breaker includes a fixed contact that is fixedly installed and a movable contact that is provided to be movable. The movable contact is configured to move toward or away from the fixed contact. When the movable contact is in contact with the fixed contact, the power source and the load can be energized. When an abnormal current occurs, the movable contact is separated from the fixed contact, thereby interrupting the current flow between the power source and the load.

Even at the moment when the movable contact is separated from the fixed contact, current—i.e., the abnormal current—still flows through the movable contact and the fixed contact. Accordingly, when the movable contact is separated from the fixed contact, the energy of the current that was flowing is converted into a high-temperature, high-pressure flow of electrons. This converted flow of electrons is referred to as an arc.

As described above, an arc is a high-temperature, high-pressure flow of electrons. Accordingly, if the arc remains inside the circuit breaker without being discharged to the outside, there is a risk that other components of the circuit breaker may be damaged by the heat or pressure of the arc. Therefore, it is necessary to discharge the generated arc to the outside while reducing its temperature and pressure, and this process is referred to as arc extinguishment.

In order to extinguish an arc, the arc must be sufficiently and rapidly extended. The extended arc is then divided into shorter arcs (commonly referred to as minor arcs) and should be discharged to the outside. To achieve this, a circuit breaker is generally provided with an arc extinguishing device including a plurality of grids.

When an arc is generated, the heat or pressure generated along with the arc may also affect the grids. If the grids are damaged by the generated heat or pressure, the arc extinguishing capability may be reduced, potentially lowering the operational reliability of the arc extinguishing device.

Korean Patent Registration No. 10-1031975 discloses an arc extinguishing device for a direct current (DC) switch. Specifically, the patent discloses an arc extinguishing device for a DC switch, in which permanent magnets are arranged to face each other with a fixed contact and a movable contact interposed therebetween, so as to guide a generated arc.

However, the arc extinguishing device disclosed in the prior art requires separate permanent magnets for arc extinguishment. As the circuit breaker continues to be used, the magnetic force of the permanent magnets may weaken, or the permanent magnets may be damaged by the generated arc, which may lead to a reduction in the arc extinguishing capability.

Korean Patent Registration No. 10-1986552 discloses an arc extinguishing device for a DC air circuit breaker. Specifically, the patent discloses an arc extinguishing device for a DC air circuit breaker, in which an arc guide and a sealing member are disposed adjacent to an end of a grid so as to extinguish a generated arc.

However, in the arc extinguishing device disclosed in the prior art, the arc guide is disposed only at a portion adjacent to the fixed contact. Accordingly, while the arc generated at the fixed contact can be partially guided, the device does not provide a means for extinguishing the entire arc that is extended as the movable contact moves.

Furthermore, the prior arts do not provide any means for preventing the components configured to guide the arc from being damaged by the arc.
Korean Patent Registration No. 10-1031975 (2011 May 9.)
Korean Patent Registration No. 10-1986552 (2019 Jun. 7.)

### SUMMARY

The present disclosure is to solve the above problems, and the present disclosure is directed to providing an arc extinguishing device having a structure capable of preventing damage to components for extinguishing an arc caused by the generated arc.

The present disclosure is also directed to providing an arc extinguishing device having a structure capable of preventing insulation breakdown of another component configured to protect the above-described component, caused by the generated arc.

The present disclosure is also directed to providing an arc extinguishing device having a structure capable of effectively guiding the generated arc toward the above-described component.

The present disclosure is also directed to providing an arc extinguishing device having a structure in which the coupled state of a component for guiding the generated arc can be stably maintained.

The present disclosure is also directed to providing an arc extinguishing device having a structure capable of circulating the remaining arc and guiding it toward the outside.

The problems of the present disclosure are not limited to those mentioned above, and other problems not mentioned will be clearly understood by those of ordinary skill in the art from the following description.

According to an aspect of the present disclosure, provided is an arc extinguishing device comprising: a grid unit positioned to be close to a fixed contact and a movable contact to extinguish an arc generated when the fixed contact and the movable contact, which are external, are spaced apart from each other; an arc guide configured to generate gas by reacting with the generated arc, the arc guide being coupled to the grid unit and extending in one direction; and an arc runner positioned to be close to each of the grid unit and the arc guide, and configured to guide the generated arc toward the grid unit, wherein the grid unit comprises: a plurality of first grids, extending to have a predetermined height and spaced apart from each other along the one direction; and a plurality of second grids positioned close to the plurality of first grids, extending to have a height shorter than the predetermined height, and spaced apart from each other along the one direction, wherein the arc runner is positioned in a space defined by being surrounded by the plurality of second grids and the plurality of first grids.

In this case, an arc extinguishing device may be provided in which the arc guide includes a guide body that at least partially surrounds the first grids and the second grids; and a guide space formed inside the guide body and configured to at least partially accommodate the first grids and the second grids.

In addition, an arc extinguishing device may be provided in which the guide body includes a first guide body formed to have a predetermined height and configured to at least partially surround the first grids; and a second guide body formed to have a height shorter than the predetermined height, configured to be continuous with the first guide body and to at least partially surround the second grids.

In this case, an arc extinguishing device may be provided in which the guide space includes a first guide space configured to at least partially accommodate the first grids; and a second guide space configured to be in fluid communication with the first guide space and to at least partially accommodate the second grids, wherein a height of the first guide space is greater than a height of the second guide space.

In addition, an arc extinguishing device may be provided in which the arc guide includes a plurality of grid support members disposed in the guide space and spaced apart from each other in the one direction to divide the guide space into a plurality of subspaces.

In this case, an arc extinguishing device may be provided in which the arc runner includes a runner body disposed to face the plurality of first grids with the plurality of second grids interposed therebetween in the one direction; and a runner extension continuous with one end of the runner body and extending toward the first grids.

In addition, an arc extinguishing device may be provided in which the runner extension includes a first runner extension continuous with the runner body at a predetermined angle; a second runner extension continuous with the first runner extension at a predetermined angle; and a third runner extension continuous with the second runner extension at a predetermined angle.

In this case, an arc extinguishing device may be provided in which the first runner extension extends perpendicularly from the runner body, the second runner extension extends at an obtuse angle from the first runner extension, and the third runner extension extends at an obtuse angle from the second runner extension, such that the third runner extension is positioned closer to the arc guide than the first runner extension.

In addition, an arc extinguishing device may be provided in which an edge in the width direction of an end portion of the third runner extension in an extending direction is chamfered.

In this case, an arc extinguishing device may be provided in which the arc runner includes a runner arm that is continuous with the other end of the runner body and extends outward.

In addition, an arc extinguishing device may be provided in which the runner arm is provided in plurality, the plurality of runner arms being spaced apart from each other in a width direction of the runner body, and the arc runner includes a circulation space that is defined by being surrounded by the runner body and the plurality of runner arms, is open, and allows a space in which the plurality of grid units are located, to be in fluid communication with the outside.

In this case, an arc extinguishing device may be provided in which the arc extinguishing device further includes a side frame coupled to each of the arc runner and the arc guide, and the arc runner includes a runner coupling part that protrudes outward from an end in a width direction and is coupled to the side frame.

In addition, an arc extinguishing device may be provided in which the runner coupling part includes a first runner coupling part and a second runner coupling part protruding outward from an end in a width direction of the runner arm; a third runner coupling part protruding outward from an end in a width direction of the runner body; and a fourth runner coupling part protruding outward from an end in a width direction of the runner extension.

In this case, an arc extinguishing device may be provided in which the side frame includes an arc runner coupling part formed to penetrate in a thickness direction of the side frame and coupled to the runner coupling part.

In addition, an arc extinguishing device may be provided in which the arc runner extends to one of the plurality of second grids that is positioned closest to the first grid.

According to the above configuration, the arc extinguishing device according to an embodiment of the present disclosure can prevent the components for extinguishing the arc from being damaged by the generated arc.

The arc extinguishing device includes a plurality of grid units for extinguishing a generated arc. The plurality of grid units are coupled to a side frame and are arranged to be spaced apart from each other. The generated arc is discharged to the outside through one end in the height direction of the plurality of grid units.

An arc guide is coupled to the other end in the height direction of the grid units. The arc guide is coupled to a grid arm that is positioned adjacent to a location where the arc is generated among the components of the grid units. By at least partially surrounding the grid arm, the arc guide can prevent the generated arc from coming into direct contact with the grid arm.

Accordingly, the grid units provided to extinguish the generated arc can be protected from the heat or pressure generated along with the arc. As a result, damage to the components configured to extinguish the arc—namely, the grid units—can be prevented.

In addition, according to the above configuration, the arc extinguishing device according to an embodiment of the present disclosure can prevent other components configured to protect the grid units from undergoing insulation breakdown due to the generated arc.

The arc guide may be configured to surround the portion of the grid arm that faces the arc. In an embodiment in which a pair of grid arms are provided to face each other with the fixed contact and the movable contact interposed therebetween, the arc guide may surround the inner sides of the grid arms.

The arc guide includes a guide body that at least partially surrounds the grid arms, and a guide space formed inside the guide body to at least partially accommodate the grid arms.

A plurality of grid support members are provided in the guide space, spaced apart from each other along the extending direction of the guide body. The plurality of grid units accommodated in the guide space are supported by the plurality of grid support members and are thereby prevented from oscillating along their arrangement direction.

In an embodiment, the plurality of grid units may be respectively fitted into the plurality of spaces partitioned by the grid support members. Accordingly, fluid communication between the plurality of spaces and the space where the arc is generated can be blocked.

Accordingly, insulation breakdown of the grid unit, the side frame supporting the grid unit, or the arc guide protecting the grid unit due to the generated arc can be minimized.

In addition, according to the above configuration, the arc extinguishing device according to an embodiment of the present disclosure can effectively guide the generated arc toward the components.

The arc extinguishing device includes an arc runner configured to guide the arc. The arc runner is disposed to face the first grid with the second grid interposed therebetween. The arc runner may be positioned adjacent to the movable contact terminal when maximally spaced apart from the fixed contact terminal.

The arc runner includes a runner body coupled to the side frame and a runner extension extending from the runner body toward the first grid. The runner extension extends to a position where the first grid and the second grid face each other, so that a newly generated arc can be quickly guided by the arc runner.

Accordingly, the generated arc can be quickly guided by the arc runner and proceed toward the grid unit to be extinguished.

In addition, according to the above configuration, the arc extinguishing device according to an embodiment of the present disclosure can maintain a stable coupling state of the components for guiding the generated arc.

The arc runner includes a runner arm continuous with the runner body. A plurality of runner coupling parts protrude from the outer sides in the width direction of the runner body, the runner arm, and the runner extension. The plurality of runner coupling parts are coupled to a plurality of arc runner coupling parts formed in the side frame.

At least one of the plurality of runner coupling parts may have a different shape from at least one of the other runner coupling parts. Similarly, at least one of the plurality of arc runner coupling parts may have a different shape from at least one of the other arc runner coupling parts.

Accordingly, the coupling state between the arc runner and the side frame can be stably maintained.

In addition, according to the above configuration, the arc extinguishing device according to an embodiment of the present disclosure can circulate the remaining arc and guide it toward the outside.

A plurality of runner arms may be provided. The plurality of runner arms may be spaced apart from each other along the width direction of the runner body. A space partially surrounded by the runner arms and the runner body is defined as a circulation space. The circulation space places the arc generation space in fluid communication with an external space of the arc extinguishing device.

An arc, among the generated arcs, that fails to pass through the support frame or the cover frame and returns to the arc generation space, proceeds in a different direction to the outside of the arc extinguishing device through the circulation space. The progressing arc then proceeds again toward the arc generation space, passes through the grid unit, is extinguished, and then discharged to the outside of the arc extinguishing device.

Accordingly, the generated arc may circulate between the inside and the outside of the arc extinguishing device and proceed toward the grid unit. As a result, the amount of residual arc remaining inside the arc extinguishing device can be minimized.

Advantageous effects of the present disclosure are not limited to the above-described effects, and should be understood to include all effects that can be inferred from the configuration of the disclosure described in the detailed description or claims of the present disclosure.

### BRIEF DESCRIPTION OF THE DRAWINGS

FIG. 1 is a perspective view illustrating an arc extinguishing device according to an embodiment of the present disclosure.

FIG. 2 is an exploded perspective view illustrating the arc extinguishing device of FIG. 1.

FIG. 3 is a perspective view illustrating a side frame included in the arc extinguishing device of FIG. 1.

FIG. 4 is a perspective view illustrating a support frame and a cover frame included in the arc extinguishing device of FIG. 1.

FIG. 5 is an exploded perspective view illustrating the support frame and the cover frame of FIG. 4.

FIG. 6 is a plan view illustrating the support frame of FIG. 4.

FIG. 7 is a perspective view illustrating a grid unit included in the arc extinguishing device of FIG. 1.

FIG. 8 is a side view illustrating the grid unit of FIG. 7.

FIG. 9 is a perspective view illustrating an arc runner included in the arc extinguishing device of FIG. 1.

FIG. 10 is a side view illustrating the arc runner of FIG. 9.

FIG. 11 is a perspective view illustrating an arc guide included in the arc extinguishing device of FIG. 1.

FIG. 12 is a side view illustrating the arc guide of FIG. 11.

FIGS. 13 and 14 are a partially cut-away perspective view (FIG. 13) and a side cross-sectional view (FIG. 14) illustrating the arc flow process formed in the arc extinguishing device according to an embodiment of the present disclosure.

### DETAILED DESCRIPTION

Hereinafter, exemplary embodiments of the present disclosure will be described in detail so that those of ordinary skill in the art can readily implement the present disclosure with reference to the accompanying drawings. The present disclosure may be embodied in many different forms and is not limited to the embodiments set forth herein. In the drawings, parts unrelated to the description are omitted for clarity of description of the present disclosure, and throughout the specification, same or similar reference numerals denote same elements.

The words and terms used in the present specification and claims should not be interpreted as being limited to their ordinary or dictionary meanings, but should be construed as having meanings and concepts consistent with the technical spirit of the present disclosure, in accordance with the principle that an inventor may define terms and concepts to best describe their disclosure.

Accordingly, the embodiments described in the present specification and the configurations shown in the drawings correspond to preferred embodiments of the present disclosure, and do not represent all the technical idea of the present disclosure, so the configurations may have various examples of equivalent and modification that can replace them at the time of filing the present disclosure.

In the following description, in order to clarify the features of the present disclosure, descriptions of some components may be omitted.

### 1. TERM DEFINITION

The term “fluid communication” used in the following description refers to a state in which one or more members are connected so as to allow fluid flow between them. In an embodiment, the fluid communication may be established by members such as conduits, pipes, or tubes. In the following description, the term “fluid communication” may be used to mean that one or more members are “fluidly connected” to each other.

The term “electrical connection” used in the following description refers to a state in which one or more members are connected so as to allow the transmission of electric current or electrical signals between them, and may be variously referred to as “electrical connection,” “energization,” “energizable connection,” “electrically connected state,” “enabled current flow,” “current-conducting state,” or “electrical conduction.” In an embodiment, the electrical connection may be established in a wired form through a conducting wire member such as a wire, or in a wireless form through technologies such as Bluetooth, Wi-Fi, or RFID. In an embodiment, the electrical connection may include the meaning of “electrical communication.”

The term “fluid” used in the following description refers to any form of material that flows by external force and whose shape or volume can be changed. In an embodiment, the fluid may be a liquid such as water or a gas such as air.

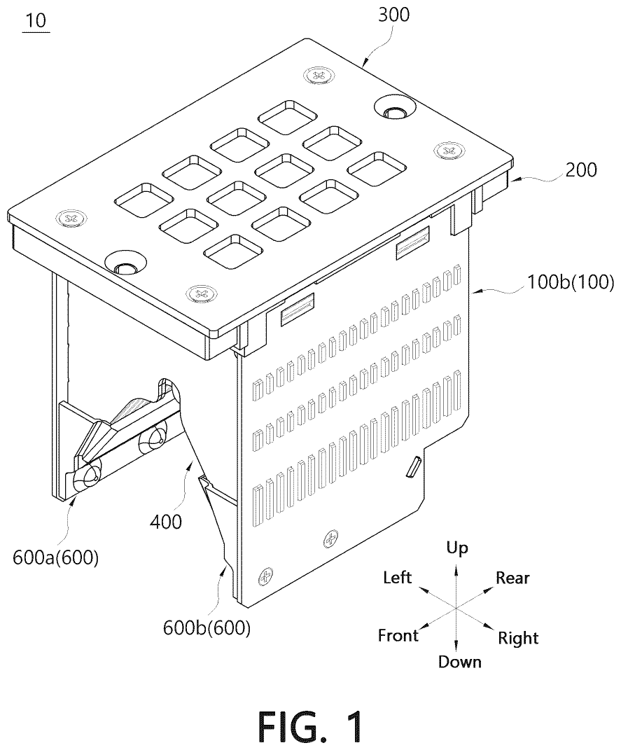

The terms “above or upper side”, “below or lower side”, “left side”, “right side”, “front side”, and “rear side” used in the following description will be understood with reference to the coordinate system shown in FIG. 1.

### 2. DESCRIPTION OF THE CONFIGURATION OF THE ARC EXTINGUISHING DEVICE 10 ACCORDING TO AN EMBODIMENT OF THE PRESENT DISCLOSURE

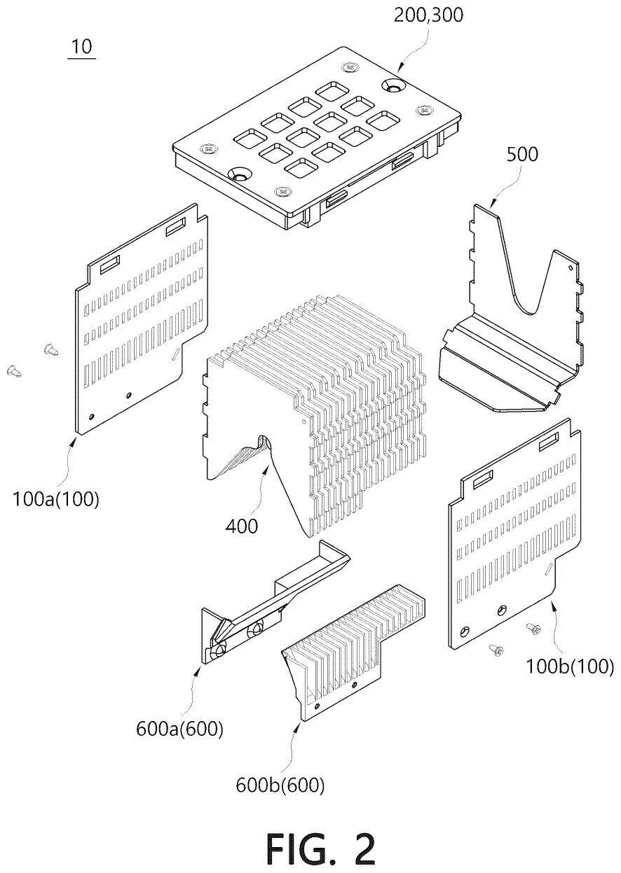

Referring to FIGS. 1 and 2, an arc extinguishing device 10 according to an embodiment of the present disclosure is illustrated. The arc extinguishing device 10 shown in the illustrated embodiment is provided in a circuit breaker (not shown) that is electrically connected to an external power source and load. The arc extinguishing device 10 may extinguish an arc, which is generated when a fixed contact and a movable contact are spaced apart from each other, to the outside of the circuit breaker (not shown).

In the illustrated embodiment, the arc extinguishing device 10 includes a side frame 100, a support frame 200, a cover frame 300, a grid unit 400, an arc runner 500, and an arc guide 600. Hereinafter, each component of the arc extinguishing device 10 will be described in detail with reference to the accompanying drawings, except that the arc guide 600 will be described separately.

### (1) Description of the Side Frame 100

The side frame 100 forms a part of the external shape of the arc extinguishing device 10. The side frame 100 is coupled to other components of the arc extinguishing device 10, namely, the support frame 200, the cover frame 300, the grid unit 400, the arc runner 500, and the arc guide 600. The side frame 100 supports the support frame 200, the cover frame 300, the grid unit 400, the arc runner 500, and the arc guide 600.

The side frame 100 is coupled to the support frame 200. In the illustrated embodiment, an upper end portion of the side frame 100 is coupled to the support frame 200.

The side frame 100 is coupled to the cover frame 300. In the illustrated embodiment, an upper end portion of the side frame 100 is indirectly coupled to the cover frame 300 by the support frame 200.

The side frame 100 is coupled to the grid unit 400. In the illustrated embodiment, an inner portion of the side frame 100 is coupled to respective ends of the grid unit 400 in the width direction.

The side frame 100 is coupled to the arc runner 500. In the illustrated embodiment, a rear portion of the side frame 100 is coupled to the arc runner 500.

The side frame 100 is coupled to the arc guide 600. In the illustrated embodiment, a lower inner portion of the side frame 100 is coupled to the arc guide 600. Accordingly, the amount of the generated arc that comes into direct contact with the side frame 100 is minimized, thereby preventing damage to the side frame 100.

A plurality of side frames 100 may be provided. The plurality of side frames 100 may be spaced apart from each other and may be coupled to respective components of the arc extinguishing device 10 at different positions. In the illustrated embodiment, the side frames 100 include two side frames: a first side frame 100a disposed on the left side and a second side frame 100b disposed on the right side.

The first side frame 100a is coupled to the left-side portions of the respective components of the arc extinguishing device 10 described above. The second side frame 100b is coupled to the right-side portions of the respective components of the arc extinguishing device 10 described above. The grid unit 400, the arc runner 500, and the arc guide 600 are positioned between the first side frame 100a and the second side frame 100b.

The first side frame 100a and the second side frame 100b differ in position, but are identical in other structures and functions. Accordingly, in the following description, common descriptions will refer to both the first side frame 100a and the second side frame 100b collectively as the side frame 100.

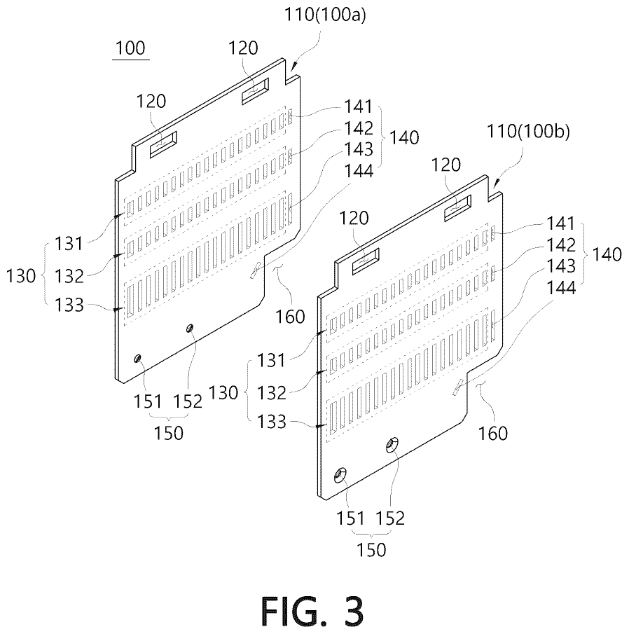

In the embodiment illustrated in FIG. 3, the side frame 100 includes a side body 110, a support frame coupling part 120, a grid coupling part 130, an arc runner coupling part 140, a side fastening hole 150, and a side space 160.

The side body 110 forms the body of the side frame 100. The side body 110 is coupled to other components of the arc extinguishing device 10.

The side body 110 may have any shape that allows it to be coupled to other components of the arc extinguishing device 10 and support them. In the illustrated embodiment, the side body 110 is provided in the form of a plate having a height in the vertical direction, a width in the front-rear direction, and a thickness in the left-right direction.

At this time, a side space 160 is formed at one side of the side body 110 facing the arc runner 500—specifically, at a lower portion of the rear side in the illustrated embodiment. Accordingly, sufficient space may be secured for the arc runner 500 to extend.

One end portion of the side body 110 in the height direction—specifically, an upper end portion in the illustrated embodiment—is coupled to the support frame 200.

Another portion of the side body 110 in the height direction—specifically, an intermediate portion in the illustrated embodiment—is coupled to the grid unit 400 and the arc runner 500. Still another end portion of the side body 110 in the height direction—specifically, a lower end portion in the illustrated embodiment—is coupled to the arc guide 600.

Inside the side body 110, a support frame coupling part 120, a grid coupling part 130, an arc runner coupling part 140, and a side fastening hole 150 are formed to penetrate through the side body 110. At one side of the side body 110—specifically, at a lower portion of the rear side—a side space 160 is formed.

The support frame coupling part 120 is a portion of the side body 110 that is coupled to the support frame 200. The support frame coupling part 120 is formed to penetrate through the side body 110 in the thickness direction—specifically, in the left-right direction in the illustrated embodiment. A support frame coupling protrusion 214 of the support frame 200 is inserted and coupled into the support frame coupling part 120.

The support frame coupling part 120 may have any shape capable of accommodating the support frame coupling protrusion 214. In the illustrated embodiment, the support frame coupling part 120 is a space having a rectangular cross-section in which the length in the front-rear direction is greater than the length in the vertical direction. The shape of the support frame coupling part 120 may vary depending on the shape of the support frame coupling protrusion 214.

The support frame coupling part 120 is formed to penetrate through the side body 110. At this time, the support frame coupling part 120 may be positioned at one side of the side body 110 facing the support frame 200—specifically, near an upper end portion in the illustrated embodiment.

A plurality of support frame coupling parts 120 may be formed. The plurality of support frame coupling parts 120 may be arranged at different positions and may be respectively coupled to a plurality of support frame coupling protrusions 214 formed at different positions. In the illustrated embodiment, two support frame coupling parts 120 are formed and are respectively positioned near a front end and a rear end of the upper end portion of the side body 110.

The number and arrangement of the support frame coupling parts 120 may vary depending on the number and arrangement of the support frame coupling protrusions 214.

A grid coupling part 130 is formed below the support frame coupling part 120.

The grid coupling part 130 is a portion of the side body 110 that is coupled to the grid unit 400. The grid coupling part 130 is formed to penetrate through the side body 110 in the thickness direction—specifically, in the left-right direction in the illustrated embodiment. A grid coupling protrusion 450 of the grid unit 400 is inserted and coupled into the grid coupling part 130.

The grid coupling part 130 may have any shape capable of accommodating the grid coupling protrusion 450. In the illustrated embodiment, the grid coupling part 130 is a space having a rectangular cross-section in which the length in the vertical direction is greater than the length in the front-rear direction. The shape of the grid coupling part 130 may vary depending on the shape of the grid coupling protrusion 450.

The grid coupling part 130 is formed to penetrate through the side body 110. At this time, the grid coupling part 130 may be positioned at an intermediate portion of the side body 110.

The grid coupling part 130 may be divided into a plurality of groups. Different grid coupling protrusions 450 may be respectively inserted and coupled into the respective groups of the grid coupling part 130. In the illustrated embodiment, the grid coupling part 130 is divided into three groups, including a first grid coupling part 131, a second grid coupling part 132, and a third grid coupling part 133.

The first grid coupling part 131, the second grid coupling part 132, and the third grid coupling part 133 may each be provided in plurality. In the illustrated embodiment, the first to third grid coupling parts 131, 132, and 133 each include nineteen through holes spaced apart from one another in the front-rear direction.

A first grid coupling protrusion 451 is inserted and coupled into the first grid coupling part 131. The first grid coupling part 131 is positioned at the uppermost location among the plurality of groups of the grid coupling part 130.

The second grid coupling part 132 is positioned below the first grid coupling part 131.

A second grid coupling protrusion 452 is inserted and coupled into the second grid coupling part 132. The second grid coupling part 132 is positioned between the first grid coupling part 131 and the third grid coupling part 133 along the vertical direction of the side body 110.

The third grid coupling part 133 is positioned below the second grid coupling part 132.

A third grid coupling protrusion 453 is inserted and coupled into the third grid coupling part 133. The third grid coupling part 133 is positioned below the second grid coupling part 132 along the vertical direction of the side body 110. In other words, the third grid coupling part 133 is positioned at the lowermost location among the grid coupling parts 130.

The number, arrangement, and shape of the first to third grid coupling parts 131, 132, and 133 described above may vary depending on the number of the grid units 400 and the arrangement and shape of the grid coupling protrusions 451, 452, and 453.

An arc runner coupling part 140 is formed in a direction in which the plurality of grid coupling parts 130 are arranged side by side—specifically, at the rear side in the illustrated embodiment.

The arc runner coupling part 140 is a portion of the side body 110 that is coupled to the arc runner 500. The arc runner coupling part 140 is formed to penetrate through the side body 110 in the thickness direction—specifically, in the left-right direction in the illustrated embodiment. A runner coupling part 550 of the arc runner 500 is inserted and coupled into the arc runner coupling part 140.

The arc runner coupling part 140 may have any shape capable of accommodating the runner coupling part 550. In the illustrated embodiment, the arc runner coupling part 140 is a space having a rectangular cross-section in which the length in the vertical direction is greater than the length in the front-rear direction. The shape of the arc runner coupling part 140 may vary depending on the shape of the runner coupling part 550.

The arc runner coupling part 140 is formed to penetrate through the side body 110. At this time, the arc runner coupling part 140 may be positioned near one longitudinal end of the side body 110—specifically, near the rear end in the illustrated embodiment.

A plurality of arc runner coupling parts 140 may be provided. The plurality of arc runner coupling parts 140 may be spaced apart from each other and may be respectively coupled to the plurality of runner coupling parts 550.

In the illustrated embodiment, the arc runner coupling parts 140 include four parts—namely, a first arc runner coupling part 141, a second arc runner coupling part 142, a third arc runner coupling part 143, and a fourth arc runner coupling part 144—which are spaced apart from each other along the height direction, that is, the vertical direction, of the side body 110.

The first arc runner coupling part 141 is coupled to a first runner coupling part 551, and the second arc runner coupling part 142 is coupled to a second runner coupling part 552. In addition, the third arc runner coupling part 143 is coupled to a third runner coupling part 553, and the fourth arc runner coupling part 144 is coupled to a fourth runner coupling part 554.

The shape and arrangement of the first to fourth arc runner coupling parts 141, 142, 143, and 144 may be determined to correspond to the shape and arrangement of the first to fourth runner coupling parts 551, 552, 553, and 554. In the illustrated embodiment, the first to third arc runner coupling parts 141, 142, and 143 are formed to have rectangular cross-sections that are elongated in the vertical direction. In addition, the fourth arc runner coupling part 144 is formed to have a rectangular cross-section that is elongated at a predetermined angle with respect to the vertical direction, so as to be inclined.

The number and arrangement of the arc runner coupling parts 140 may vary depending on the number and arrangement of the runner coupling parts 550.

A side fastening hole 150 is formed below the grid coupling part 130.

The side fastening hole 150 is a portion of the side body 110 that is coupled to the arc guide 600. The side fastening hole 150 is formed to penetrate through the side body 110 in the thickness direction—specifically, in the left-right direction in the illustrated embodiment. A fastening member (not designated in the drawings), which passes through a fastening hole (not designated in the drawings) of the arc guide 600, is inserted and coupled into the side fastening hole 150.

In an embodiment, the side fastening hole 150 may be screw-fitted with a fastening member (not designated in the drawings). In this embodiment, threads may be formed on the inner circumferential surface of the side fastening hole 150.

A plurality of side fastening holes 150 may be formed. The plurality of side fastening holes 150 may be spaced apart from each other along the longitudinal direction of the side body 110—specifically, in the front-rear direction in the illustrated embodiment. The plurality of side fastening holes 150 may be aligned with and respectively coupled to a plurality of fastening holes (not designated in the drawings) formed in the arc guide 600.

In the illustrated embodiment, the side fastening holes 150 include a first side fastening hole 151 and a second side fastening hole 152.

The first side fastening hole 151 is coupled to a fastening member (not designated in the drawings) that couples the side body 110 to the arc guide 600. The first side fastening hole 151 is positioned near one longitudinal end of the side body 110—specifically, near a front end of the lower side in the illustrated embodiment.

The first side fastening hole 151 may have any shape that allows it to be penetratively coupled to a fastening member (not designated in the drawings). In the illustrated embodiment, the first side fastening hole 151 has a circular cross-section and is formed in a cylindrical shape having a thickness in the left-right direction.

The second side fastening hole 152 is coupled to a fastening member (not designated in the drawings) that couples the side body 110 to the arc guide 600. The second side fastening hole 152 is positioned near an intermediate portion in the longitudinal direction of the side body 110—specifically, near a middle portion in the front-rear direction of the lower side in the illustrated embodiment.

The second side fastening hole 152 may have any shape that allows it to be penetratively coupled to a fastening member (not designated in the drawings). In the illustrated embodiment, the second side fastening hole 152 has a circular cross-section and is formed in a cylindrical shape having a thickness in the left-right direction.

The number and arrangement of the second side fastening holes 152 may vary depending on the number and arrangement of the fastening holes (not shown) of the arc guide 600 and the fastening members (not designated in the drawings).

The side space 160 is a space formed at one side of the side body 110. A portion of the side space 160 is surrounded by the side body 110, and another portion of the side space 160 is open.

The side space 160 is recessed into the above-mentioned one side of the side body 110. The side space 160 may be partially surrounded by a runner extension 530 of the arc runner 500.

The side space 160 may be formed to correspond to the shape of the runner extension 530. In the illustrated embodiment, the side space 160 is formed as a polygonal pillar-shaped space having a length in the front-rear direction, a height in the vertical direction, and a width in the left-right direction. The shape of the side space 160 may be determined according to the shapes of the runner body 510 and the runner extension 530 of the arc runner 500.

### (2) Description of the Support Frame 200

The support frame 200 couples the side frame 100 and the cover frame 300. A space is formed inside the support frame 200 to serve as a path through which a generated arc is extinguished and discharged. A member for filtering foreign substances or the like mixed with the extinguished arc may be provided in the space of the support frame 200.

The support frame 200 is coupled to the side frame 100. In an embodiment in which the side frame 100 includes a pair of frames, namely, a first side frame 100a and a second side frame 100b, the support frame 200 may be respectively coupled to the first and second side frames 100a and 100b. In the illustrated embodiment, the left and right portions of the support frame 200 are coupled to upper portions of the side frame 100.

The support frame 200 is coupled to the cover frame 300. An upper portion of the support frame 200 and the space therein are disposed to be covered by the cover frame 300. Accordingly, the member accommodated in the space can be prevented from being unintentionally detached. The space may be in fluid communication with the outside through the cover frame 300.

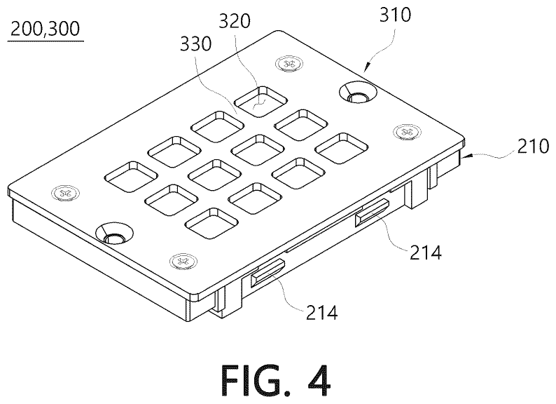

In the embodiments illustrated in FIGS. 4 to 6, the support frame 200 includes a support body 210, a support plate 220, and a mesh plate 230.

The support body 210 forms the body of the support frame 200. The support body 210 is a portion of the support frame 200 that is coupled to other components of the arc extinguishing device 10. Specifically, the support body 210 is coupled to the side frame 100 and the cover frame 300.

A space is formed inside the support body 210. The support plate 220 and the mesh plate 230 are positioned in the space. The grid unit 400 is positioned below the space. The upper side of the space is in fluid communication with the outside of the cover frame 300. Accordingly, the space accommodating the grid unit 400 is in fluid communication with the outside of the cover frame 300, allowing the generated arc to be extinguished and discharged to the outside.

The support body 210 may have any shape that allows it to be coupled to the side frame 100 and the cover frame 300, and to provide fluid communication between the internal space and the outside of the arc extinguishing device 10. In the illustrated embodiment, the support body 210 has a rectangular cross-section and is formed in the shape of a rectangular pillar having a height in the vertical direction. At this time, a space is formed inside the support body 210 to penetrate in the height direction—specifically, in the vertical direction.

In the illustrated embodiment, the support body 210 includes a plate accommodating portion 211, a plate support portion 212, a buffer space 213, and a support frame coupling protrusion 214.

The plate accommodating portion 211 accommodates the support plate 220 and the mesh plate 230. The plate accommodating portion 211 forms a part of the space formed inside the support body 210. In the illustrated embodiment, the plate accommodating portion 211 forms an upper portion of the internal space of the support body 210.

The plate accommodating portion 211 may be formed in a shape corresponding to the shapes of the support plate 220 and the mesh plate 230. In the illustrated embodiment, the plate accommodating portion 211 is formed as a rectangular pillar-shaped space having a rectangular cross-section in which the length in the front-rear direction is greater than the length in the left-right direction, and having a height in the vertical direction.

One side of the plate accommodating portion 211 that faces the cover frame 300—specifically, the upper side in the illustrated embodiment—is open. The support plate 220 and the mesh plate 230 are accommodated in the plate accommodating portion 211 through the one side.

The other side of the plate accommodating portion 211 that faces the grid unit 400—specifically, the lower side in the illustrated embodiment—is open. An arc generated from the grid unit 400 may travel into the plate accommodating portion 211 through the other side.

The plate support portion 212 is positioned below the plate accommodating portion 211.

The plate support portion 212 supports the support plate 220 and the mesh plate 230 accommodated in the plate accommodating portion 211. In addition, the plate support portion 212 extends to surround the buffer space 213 from the outside. In other words, the plate support portion 212 defines the cross-sectional area of the buffer space 213 to be smaller than that of the plate accommodating portion 211.

Accordingly, the support plate 220 and the mesh plate 230 accommodated in the plate accommodating portion 211 are supported by the plate support portion 212, thereby preventing unintended entry into the buffer space 213.

The plate support portion 212 protrudes inward from the inner circumferential surface of the support body 210. The plate support portion 212 extends along the inner circumference of the support body 210.

The plate support portion 212 may be divided into a plurality of sections. In the illustrated embodiment, the plate support portion 212 may be divided into a pair of first sections arranged in the front-rear direction and extending in the left-right direction, and a pair of second sections arranged in the left-right direction and extending in the front-rear direction.

The space surrounded by the plate support portion 212 is defined as the buffer space 213.

The buffer space 213 forms another portion of the space formed inside the support body 210. In the illustrated embodiment, the buffer space 213 forms a lower portion of the internal space of the support body 210.

The buffer space 213 is located between the plate accommodating portion 211 and the grid unit 400. The buffer space 213 is formed to penetrate in the height direction of the support frame 200—specifically, in the vertical direction in the illustrated embodiment.

One side of the buffer space 213 that faces the plate accommodating portion 211—specifically, the upper side in the illustrated embodiment—is open and in fluid communication with the plate accommodating portion 211. The other side of the buffer space 213 that faces the grid unit 400—specifically, the lower side in the illustrated embodiment—is open and in fluid communication with the grid unit 400.

Accordingly, the arc extinguished while passing through the grid unit 400 may be discharged to the outside sequentially through the buffer space 213 and the plate accommodating portion 211.

The support frame coupling protrusion 214 is a portion of the support body 210 that is coupled to the side body 110. The support frame coupling protrusion 214 is inserted and coupled into the support frame coupling part 120 of the side frame 100.

The support frame coupling protrusion 214 is located on an outer circumferential surface of the support body 210. The support frame coupling protrusion 214 protrudes outward from the support body 210.

The support frame coupling protrusion 214 may have any shape that allows it to be inserted into the support frame coupling part 120. In the illustrated embodiment, the support frame coupling protrusion 214 is formed to extend in the front-rear direction, to have a width in the left-right direction, and to have a height in the vertical direction.

At this time, the support frame coupling protrusion 214 may have a varying cross-sectional area along its height direction. In the illustrated embodiment, the upper cross-sectional area of the support frame coupling protrusion 214 is greater than the lower cross-sectional area. In other words, one outer surface of the support frame coupling protrusion 214 extends obliquely inward toward the lower side.

Accordingly, the support frame coupling protrusion 214 can be easily inserted and coupled into the support frame coupling part 120. In addition, once inserted into the support frame coupling part 120, the support frame coupling protrusion 214 is prevented from being unintentionally detached from the support frame coupling part 120 without an external force.

A plurality of support frame coupling protrusions 214 may be formed. The plurality of support frame coupling protrusions 214 may be spaced apart from each other and arranged at different positions, and may be respectively coupled to a plurality of support frame coupling parts 120.

In the illustrated embodiment, the support frame coupling protrusions 214 are provided in pairs on the left outer surface and the right outer surface of the support body 210, for a total of four. At this time, each pair of support frame coupling protrusions 214 formed on the left and right outer surfaces of the support body 210 are spaced apart from each other in the front-rear direction.

The number and arrangement of the support frame coupling protrusions 214 may vary depending on the number and arrangement of the support frame coupling parts 120.

The support plate 220 allows the space in which the grid unit 400 is located to be in partial fluid communication with the outside of the arc extinguishing device 10. The support plate 220 supports the mesh plate 230 from below.

The support plate 220 is accommodated in the plate accommodating portion 211. At this time, the outer circumference of the support plate 220 is supported by the plate support portion 212, so that the support plate 220 does not proceed into the buffer space 213.

The support plate 220 may be formed in a shape corresponding to the cross-sectional shape of the plate accommodating portion 211. In the illustrated embodiment, the support plate 220 has a rectangular plate shape and is formed to have a thickness in the vertical direction, with a cross-section in which a protrusion is formed at one end in the extending direction and a recessed portion is formed at the other end in the extending direction.

The support plate 220 supports the mesh plate 230 from below. Due to the support plate 220, the mesh plate 230 is also prevented from advancing into the buffer space 213.

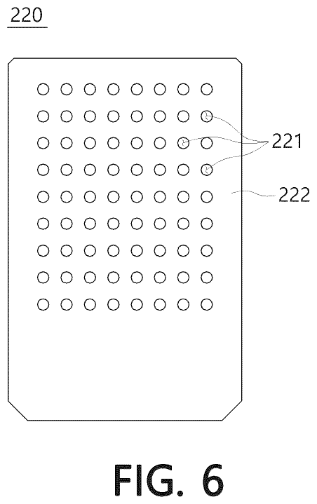

In the embodiment illustrated in FIG. 6, the support plate 220 includes a support fluid communication hole 221 and a plate body 222.

The support fluid communication hole 221 is formed through the interior of the support plate 220 to allow partial fluid communication between the space in which the grid unit 400 is located and the outside of the arc extinguishing device 10. An arc generated and extinguished in the grid unit 400 may pass sequentially through the support fluid communication hole 221 and the mesh plate 230 and be discharged to the outside.

The support fluid communication holes 221 may be provided in plurality. The plurality of support fluid communication holes 221 are spaced apart from each other to allow fluid communication between the space in which the grid unit 400 is located and the outside at different positions. In the illustrated embodiment, the plurality of support fluid communication holes 221 are positioned toward the front side so as to be opposite to the arc runner 500 located at the rear side. This is to increase the internal pressure of an initially generated arc, so that the generated arc is rapidly extended and introduced into the arc extinguishing device 10.

Specifically, a fixed contact and a movable contact are positioned opposite to the arc runner 500. At this time, no support fluid communication hole 221 is formed in the portion of the support plate 220 that is located above the fixed contact and the movable contact. Accordingly, the space between the support fluid communication holes 221 and the fixed contact and the movable contact is partially sealed, allowing the pressure of the initially generated arc to increase rapidly.

The plate body 222 is defined as the remaining portion of the support plate 220 excluding the portions in which the plate fluid communication holes 221 are formed. That is, the plate body 222 is configured to block fluid communication between the space in which the grid unit 400 is located and the outside of the arc extinguishing device 10.

As will be described later, a portion of the generated arc may be discharged to the outside of the arc extinguishing device 10 through the support fluid communication holes 221. In contrast, another portion of the generated arc may collide with the plate body 222 and then proceed in a direction opposite to the support plate 220.

At this time, a circulation space 540 is formed in the arc runner 500, forming a passage through which the other portion of the arc, which has bounced back, can proceed again toward the grid unit 400. Accordingly, the arc that has collided with the plate body 222 can be extinguished again and discharged to the outside.

The mesh plate 230 is configured to filter foreign substances or the like remaining in the arc that is extinguished and discharged. The foreign substances remaining in the arc are prevented by the mesh plate 230 from being undesirably discharged to the outside of the arc extinguishing device 10. Accordingly, damage to other components of the arc extinguishing device 10 or of the circuit breaker (not shown) caused by such foreign substances or the like can be prevented.

The mesh plate 230 is accommodated in the plate accommodating portion 211. In this case, the mesh plate 230 is disposed to cover the support plate 220 and is supported by the support plate 220.

The mesh plate 230 may be provided in any form capable of filtering foreign substances or the like remaining in the arc while being accommodated in the plate accommodating portion 211. In the illustrated embodiment, the mesh plate 230 is formed in a rectangular plate shape corresponding to the support plate 220.

A plurality of mesh plates 230 may be provided. The plurality of mesh plates 230 may be stacked in the thickness direction to respectively filter foreign substances or the like remaining in the arc passing therethrough. In the illustrated embodiment, six mesh plates 230 are provided and stacked in the vertical direction. Accordingly, the arc passing through the mesh plates 230 may be filtered multiple times and discharged to the outside of the arc extinguishing device 10.

In the above embodiment, the mesh plate 230 positioned at the lowest side is supported by the support plate 220. The mesh plate 230 positioned at the highest side is covered by the cover frame 300.

In an embodiment, the mesh plate 230 may include mesh through holes (not shown) and mesh ribs (not shown).

In the above embodiment, the mesh through holes (not shown) are formed to penetrate in the thickness direction of the mesh plate 230, forming passages through which the arc can pass. The mesh through holes (not shown) are defined by being surrounded by mesh ribs (not shown). The mesh through holes (not shown) may have any shape that allows the arc to pass through while blocking the passage of foreign substances or the like remaining in the arc.

The mesh through holes (not shown) are surrounded by mesh ribs (not shown). The mesh ribs (not shown) are provided in plurality and extend in the longitudinal and width directions of the mesh plate 230. In this case, the mesh ribs (not shown) extending in the same direction are spaced apart from each other, forming the mesh through holes (not shown) therebetween.

A plurality of mesh through holes (not shown) and a plurality of mesh ribs (not shown) may be formed. The plurality of mesh through holes (not shown) and the plurality of mesh ribs (not shown) may be alternately arranged along the longitudinal direction and the width direction of the mesh plate 230.

In addition, the plurality of mesh through holes (not shown) and the plurality of mesh ribs (not shown), which are respectively formed in each of the stacked mesh plates 230, may be alternately arranged along the stacking direction—specifically, the vertical direction in the illustrated embodiment.

Therefore, the arc that has passed through the mesh through holes (not shown) formed in one of the mesh plates 230 may travel in a horizontal direction and then pass through the mesh through holes (not shown) formed in another mesh plate 230. Accordingly, the filtering effect for foreign substances or the like remaining in the arc can be improved.

### (3) Description of the Cover Frame 300

The cover frame 300 covers the support frame 200 and is coupled to the support frame 200. The cover frame 300 supports the support plate 220 and the mesh plate 230, which are provided in the support frame 200, from above. Even when a breaking operation is performed and pressure or the like is generated, the support plate 220 and the mesh plate 230 may be prevented from being unintentionally detached by being held in place with the cover frame 300.

The cover frame 300 is coupled to the support frame 200. A plurality of through holes—specifically, cover through holes 320, which will be described later—are formed in the cover frame 300 to place the internal space of the support body 210—namely, the plate accommodating portion 211 and the buffer space 213—in fluid communication with the outside. Accordingly, an arc that has been extinguished after passing through the grid unit 400 may be discharged to the outside sequentially via the support frame 200 and the cover frame 300.

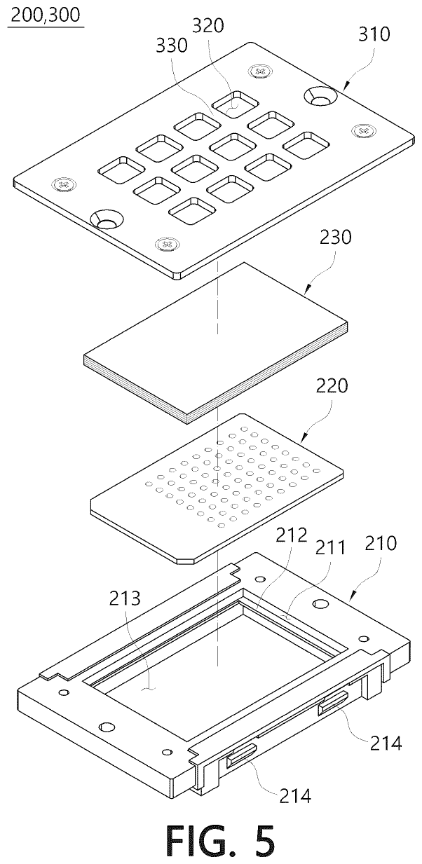

In the embodiments illustrated in FIGS. 4 to 5, the cover frame 300 includes a cover body 310, cover through holes 320, and cover ribs 330.

The cover body 310 forms the body of the cover frame 300. The cover body 310 may be formed in a shape corresponding to the support body 210 so as to cover a space formed inside the support body 210 and be coupled to the support body 210. In the illustrated embodiment, the cover body 310 has a polygonal cross-section whose length in the front-rear direction is greater than that in the left-right direction, and has a thickness in the vertical direction.

A cover through hole 320 and a cover rib 330 are provided inside the cover body 310.

The cover through hole 320 is formed to penetrate the inside of the cover body 310 and bring the internal space of the support body 210 into fluid communication with the outside. An arc that has passed through the support plate 220 and the mesh plate 230 accommodated in the support body 210 may be discharged to the outside of the arc extinguishing device 10 through the cover through hole 320.

The cover through hole 320 is formed to penetrate through the cover body 310 in the thickness direction—specifically, in the vertical direction in the illustrated embodiment. One end of the cover through hole 320 in the penetration direction—specifically, the upper end in the illustrated embodiment—is open to be in fluid communication with the outside. The other end of the cover through hole 320 in the penetration direction—specifically, the lower end in the illustrated embodiment—is open to be in fluid communication with the internal space of the support body 210.

The cover through hole 320 is surrounded by the cover rib 330. The cover rib 330 extends in the longitudinal and width directions of the cover body 310—specifically, in the front-rear and left-right directions in the illustrated embodiment—and surrounds the horizontal direction of the cover through hole 320.

The cover through hole 320 may have any shape that allows fluid communication between the internal space of the support body 210 and the outside of the arc extinguishing device 10. In the illustrated embodiment, the cover through hole 320 is formed as a plate-shaped space having a rectangular cross-section and a thickness in the vertical direction.

The cover through hole 320 and the cover rib 330 may be provided in plurality, respectively. The plurality of cover through holes 320 and the plurality of cover ribs 330 may be alternately arranged along the length and width directions of the cover body 310.

In the illustrated embodiment, four cover through holes 320 are formed in the front-rear direction and three in the left-right direction, resulting in a total of twelve. The cover ribs 330 extend between the cover through holes 320 that are arranged close to each other.

### (4) Description of the Grid Unit 400

The grid unit 400 extinguishes an arc generated when the fixed contact and the movable contact are separated while current is flowing. The generated arc is cooled, extended, moved, and divided along the grid unit 400, and then discharged to the outside of the arc extinguishing device 10. Accordingly, the grid unit 400 may be said to substantially perform the function of extinguishing the arc.

The grid unit 400 is coupled to the side frame 100. Each end of the grid unit 400 in the width direction is supported by the pair of side frames 100a and 100b.

The grid unit 400 is partially accommodated in the support frame 200. In the illustrated embodiment, the upper portion of the grid unit 400 is partially accommodated in the buffer space 213 of the support frame 200.

The grid unit 400 is positioned close to the arc runner 500. The generated arc may flow toward the grid unit 400 by the arc runner 500.

The grid unit 400 is coupled to the arc guide 600. By the arc guide 600, the generated arc may be sufficiently energized and may be extended, divided, and extinguished in the space formed between the plurality of grid units 400.

A plurality of grid units 400 may be provided. The plurality of grid units 400 may be arranged side by side with a spacing therebetween in the movement direction of the movable contact—specifically, in the front-rear direction in the illustrated embodiment. The generated arc may respectively pass through the spaces formed between the plurality of grid units 400, and may be divided, cooled, and extinguished in each of the respective spaces.

The plurality of grid units 400 may be classified into a plurality of groups according to their shapes. The plurality of groups of grid units 400 may be spaced apart from each other in the aforementioned direction—specifically, in the front-rear direction.

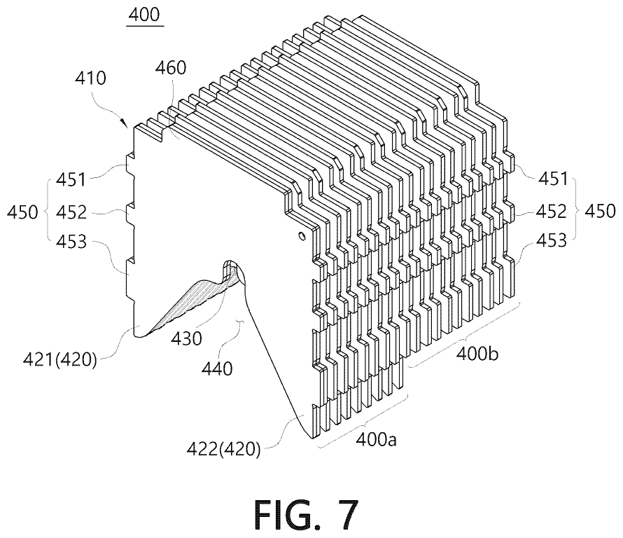

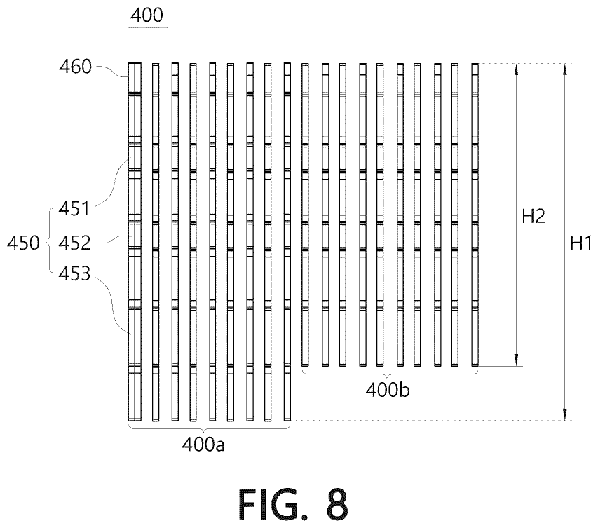

In the embodiments illustrated in FIGS. 7 to 8, the grid unit 400 may be classified into two groups, including a first grid 400a and a second grid 400b.

The first grid 400a is located at one end in the direction in which the plurality of grid units 400 are arranged side by side—specifically, at the front end in the illustrated embodiment. The first grid 400a is positioned closest to the fixed contact.

The second grid 400b is located to the rear of the first grid 400a. In this case, the second grid 400b is alternately arranged in the direction in which the plurality of grid units 400 are arranged side by side—specifically, from the front side toward the rear side in the illustrated embodiment.

That is, the first grid 400a constitutes a front portion of the plurality of grid units 400, and the second grid 400b constitutes a remaining rear portion of the plurality of grid units 400. In the illustrated embodiment, the first grid 400a includes eight (or nine) grid units located on the front side, and the second grid 400b includes ten grid units located on the rear side of the first grid 400a.

The practical benefit of distinguishing between the first grid 400a and the second grid 400b lies in the difference in their height—specifically, the length in the vertical direction in the illustrated embodiment.

That is, as shown in FIG. 8, a first height H1, which is the height of the first grid 400a, is greater than a second height H2, which is the height of the second grid 400b. In other words, the first grid 400a extends in the vertical direction by a greater length than the second grid 400b.

Accordingly, when the upper ends of the first grid 400a and the second grid 400b are positioned at the same height, the lower end of the second grid 400b is positioned higher than the lower end of the first grid 400a.

Accordingly, a space partially surrounded by the side frame 100 and the first grid 400a is formed below the second grid 400b. A runner extension 530 of the arc runner 500 may be accommodated in the space. Therefore, an arc that has moved into the space may be extended toward the grid unit 400 along the runner extension 530.

The first and second grids 400a and 400b differ in the height (i.e., the length in the vertical direction) of the grid arms 420 described above, but have the same structure and function in other respects. Accordingly, the following description will refer to them collectively as the grid unit 400 where the explanation is applicable to both.

In the embodiments illustrated in FIGS. 7 to 8, the grid unit 400 includes a grid body 410, a grid arm 420, an arc guiding space 430, an arc extension space 440, a grid coupling protrusion 450, and a frame coupling protrusion 460.

The grid body 410 forms the body of the grid unit 400. The grid body 410 substantially performs the function of dividing, cooling, and extinguishing the arc.

The grid body 410 may be provided in the form of a plate. In the illustrated embodiment, the grid body 410 is provided in the form of a rectangular plate having a length in the left-right direction greater than that in the vertical direction.

The grid body 410 is continuous with the grid arm 420. In the illustrated embodiment, the lower side of the grid body 410 is continuous with the upper side of the grid arm 420.

The grid body 410 partially surrounds the arc guiding space 430 and the arc extension space 440. In the illustrated embodiment, the grid body 410 surrounds the upper sides of the arc guiding space 430 and the arc extension space 440.

At each end of the grid body 410 in the width direction, first and second grid coupling protrusions 451 and 452 of the grid coupling protrusion 450 are provided. At one end of the grid body 410 in the height direction—specifically, the upper end in the illustrated embodiment—the frame coupling protrusion 460 is located.

The grid arm 420 is continuous with the grid body 410. The grid arm 420 extends from the lower end of the grid body 410 and partially surrounds the arc guiding space 430 or the arc extension space 440.

The grid arm 420 is coupled to the arc guide 600. The arc guide 600 coupled to the grid arm 420 may be coupled to and supported by the side frame 100.

A plurality of grid arms 420 may be formed. The plurality of grid arms 420 may be spaced apart from each other and respectively coupled to the grid body 410 at different positions. In the illustrated embodiment, a pair of grid arms 420 is provided, including a first grid arm 421 positioned on the left side and a second grid arm 422 positioned on the right side.

The first and second grid arms 421 and 422 are spaced apart from each other in the width direction of the grid body 410—specifically, in the left-right direction. In other words, the first and second grid arms 421 and 422 are disposed to face each other with the arc guiding space 430 or the arc extension space 440 interposed therebetween.

As described above, the pair of grid arms 420 provided in the first grid 400a may extend longer than the pair of grid arms 420 provided in the second grid 400b.

The third grid coupling protrusion 453 of the grid coupling protrusion 450 is formed at an outer edge of the grid arm 420.

The arc guiding space 430 guides an arc, which is generated when the fixed contact and the movable contact are separated, into the grid body 410 or a space between adjacent grid bodies 410.

The arc guiding space 430 is partially surrounded by the grid body 410 and the grid arm 420. In the illustrated embodiment, the upper side of the arc guiding space 430 is partially surrounded by the grid body 410, and the left and right sides of the arc guiding space 430 are partially surrounded by the pair of grid arms 420.

The arc guiding space 430 may be arranged such that its laterally offset position alternates along the direction in which the plurality of grid units 400 are arranged. That is, in the illustrated embodiment, the arc guiding space 430 of the grid unit 400 located at the foremost side is offset to the right. In this case, the arc guiding space 430 of another grid unit 400 positioned closest to the above-described grid unit 400 may be offset to the left.

Accordingly, the generated arc may be alternately guided along the width direction of the grid units 400 and may be guided into the grid body 410 or the space between adjacent grid bodies 410. As a result, the arc extinguishing process of the generated arc may be effectively performed.

The arc extension space 440 is a space in which a movable contact terminal (not shown) moves. The arc generated between the movable contact and the fixed contact may be extended along the moving movable contact terminal and may be guided into the grid body 410 or the space between adjacent grid bodies 410.

The arc extension space 440 is partially surrounded by the grid body 410 and the grid arm 420. In the illustrated embodiment, the upper side of the arc extension space 440 is surrounded by the grid body 410, and the widthwise sides—specifically, the left and right sides—of the arc extension space 440 are surrounded by the grid arms 420.

The arc extension space 440 is in fluid communication with the arc guiding space 430. An arc extended within the arc extension space 440 may be guided into the space defined by or between the grid bodies 410 through the arc guiding space 430.

The grid coupling protrusion 450 is a portion where the grid unit 400 is coupled to the side frame 100. The grid coupling protrusion 450 is inserted into and coupled to a grid coupling part 130 formed in the side frame 100.

The grid coupling protrusion 450 is continuous with the grid body 410 and the grid arm 420. The grid coupling protrusion 450 protrudes outward from each end in the width direction of the grid body 410 and the grid arm 420—specifically, from the left and right edges in the illustrated embodiment.

A plurality of grid coupling protrusions 450 may be provided. The plurality of grid coupling protrusions 450 may be respectively coupled to the plurality of grid coupling parts 130. In the illustrated embodiment, the grid coupling protrusions 450 include three protrusions: a first grid coupling protrusion 451, a second grid coupling protrusion 452, and a third grid coupling protrusion 453.

The first grid coupling protrusion 451 is inserted into and coupled to the first grid coupling part 131. The first grid coupling protrusion 451 is positioned at the uppermost part among the plurality of grid coupling protrusions 450. The first grid coupling protrusion 451 protrudes outward from both side edges of the grid body 410.

The second grid coupling protrusion 452 is inserted into and coupled to the second grid coupling part 132. The second grid coupling protrusion 452 is positioned in the middle part among the plurality of grid coupling protrusions 450. The second grid coupling protrusion 452 protrudes outward from both upper side edges of the grid arm 420.

The third grid coupling protrusion 453 is inserted into and coupled to the third grid coupling part 133. The third grid coupling protrusion 453 is positioned at the lowest location among the plurality of grid coupling protrusions 450. The third grid coupling protrusion 453 protrudes outward from both lower side edges of the grid arm 420.

The number, shape, and arrangement of the grid coupling protrusions 450 may vary depending on the number, shape, and arrangement of the grid coupling parts 130.

### (5) Description of Arc Runner 500

The arc runner 500 guides an arc, which is generated when the fixed contact and the movable contact are separated, toward the arc guiding space 430. The arc runner 500 is located on the downstream side of the generated arc, namely, farthest from the fixed contact. In the illustrated embodiment, the arc runner 500 is positioned at the rear side of the arc extinguishing device 10 and is located close to the rearmost one of the plurality of grid units 400.

In other words, the arc runner 500 is located farther from the first grid 400a positioned at the front side, and closer to the second grid 400b positioned at the rear side. In the illustrated embodiment, the arc runner 500 extends across the rear side and the lower side of the second grid 400b.

The arc runner 500 is coupled to the side frame 100. Both sides of the arc runner 500 in the width direction are supported by the pair of side frames 100a and 100b.

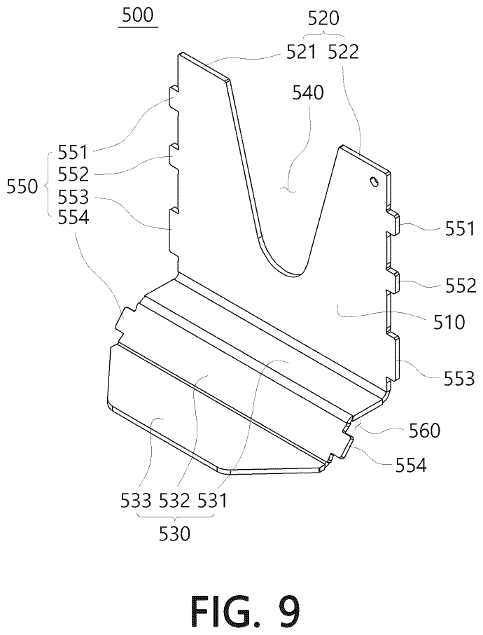

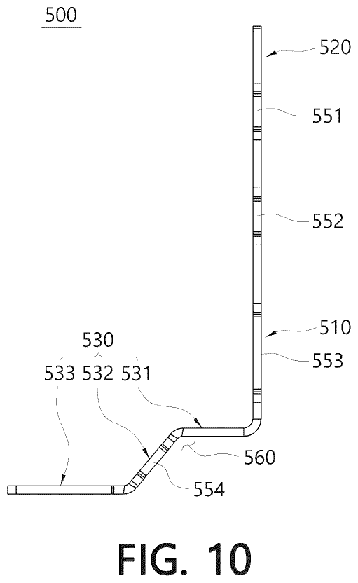

In the embodiments illustrated in FIGS. 9 to 10, the arc runner 500 includes a runner body 510, a runner arm 520, a runner extension 530, a circulation space 540, a runner coupling part 550, and a runner space 560.

The runner body 510 forms the body of the arc runner 500. The runner body 510 is continuous with other components of the arc runner 500. The runner body 510 partially overlaps, in the front-rear direction, with the grid unit 400 positioned at the rearmost side among the plurality of grid units 400.

The runner body 510 may have an arbitrary shape that is continuous with other components of the arc runner 500 and capable of guiding an arc. In the illustrated embodiment, the runner body 510 is provided in the form of a rectangular plate having a length in the left-right direction greater than that in the vertical direction.

The runner body 510 may be positioned closer to the front side than to the rear end among the edges of the side body 110. Accordingly, the runner body 510 may not be exposed to the rear side of the side body 110.

One end of the runner body 510 in the height direction—specifically, the upper end in the illustrated embodiment—is continuous with the runner arm 520. The upper end of the runner body 510, together with the runner arm 520, partially surrounds the circulation space 540.

The other end of the runner body 510 in the height direction—specifically, the lower end in the illustrated embodiment—is continuous with the runner extension 530. In addition, a runner coupling part 550 is formed at each end of the runner body 510 in the longitudinal direction, that is, at the left and right ends.

The runner arm 520 forms part of another component of the arc runner 500. The runner arm 520 is continuous with the runner body 510. The runner arm 520 extends in the height direction of the runner body 510—specifically, in the vertical direction in the illustrated embodiment.

One end of the runner arm 520 in the extending direction—specifically, the upper end in the illustrated embodiment—may be accommodated in the buffer space 213 of the support frame 200. The other end of the runner arm 520 in the extending direction—specifically, the lower end in the illustrated embodiment—is continuous with the runner body 510.

The runner arm 520 is coupled to the side frame 100. Specifically, a first runner coupling part 551 and a second runner coupling part 552 of the runner coupling part 550 are formed to protrude from outer edges of the runner arm 520. The first and second runner coupling parts 551 and 552 may be inserted into and coupled to a first arc runner coupling part 141 and a second arc runner coupling part 142, respectively.

The runner arm 520 partially surrounds the circulation space 540 together with the runner body 510. In the illustrated embodiment, the runner arm 520 surrounds the circulation space 540 in the width direction—specifically, on the left and right sides.

A plurality of runner arms 520 may be provided. The plurality of runner arms 520 may each be continuous with the runner body 510 and may be spaced apart from each other. In the illustrated embodiment, two runner arms 520 are provided, including a first runner arm 521 biased toward the left side and a second runner arm 522 biased toward the right side. The first runner arm 521 and the second runner arm 522 are arranged to face each other with the circulation space 540 interposed therebetween.

The runner extension 530 may be defined as another part of the arc runner 500. The runner extension 530 substantially serves to guide the generated arc. The runner extension 530 may extend to the lower side of the grid unit 400 and may be positioned adjacent to the fixed contact.

The runner extension 530 is continuous with the runner body 510. The runner extension 530 extends between the runner body 510 and the lower side of the grid unit 400.

One end of the runner extension 530 in the extending direction—specifically, the front end in the illustrated embodiment—may be positioned below the second grid 400b, which extends by the second height H2. As described above, since the second height H2 is shorter than the first height H1 of the first grid 400a, the runner extension 530 may extend below the second grid 400b.

The other end of the runner extension 530 in the extending direction—specifically, the rear end in the illustrated embodiment—may be continuous with the lower end of the runner body 510.

The runner extension 530 is positioned opposite to the runner arm 520. In other words, the runner extension 530 is disposed to face the runner arm 520 with the runner body 510 interposed therebetween. In the illustrated embodiment, the runner extension 530 is continuous with the lower end of the runner body 510 and is disposed to face the runner arm 520, which is continuous with the upper end of the runner body 510.

The runner extension 530 may be formed to correspond to the shape of the runner body 510. In the illustrated embodiment, the runner extension 530 is provided in the form of a plate having a width in the left-right direction. At each end of the runner extension 530 in the width direction—specifically, at the left and right edges in the illustrated embodiment—a fourth runner coupling part 554 is located.

The runner extension 530 may be divided into a plurality of parts. The plurality of parts may be continuous with each other at predetermined angles. In the illustrated embodiment, the runner extension 530 includes a first runner extension 531, a second runner extension 532, and a third runner extension 533.

The first runner extension 531 is a portion of the runner extension 530 that is continuous with the runner body 510. The first runner extension 531 is continuous with the runner body 510 at a predetermined angle. In an embodiment, the predetermined angle may be a right angle. In the above embodiment, the first runner extension 531 may extend in the horizontal direction.

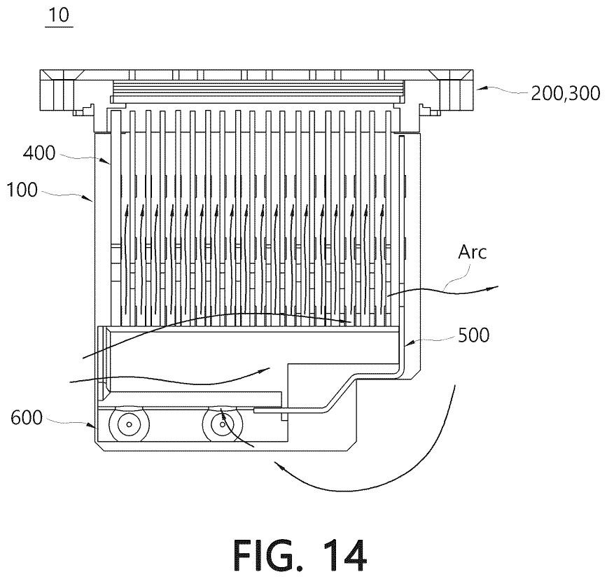

The first runner extension 531 may be positioned at the same height as, or higher than, the edge of a portion of the side body 110 that surrounds the side space 160 from above (see FIG. 14). Accordingly, the first runner extension 531 does not protrude outward from the side body 110.

One end of the first runner extension 531 in the extension direction—specifically, the front end in the illustrated embodiment—is continuous with the second runner extension 532.

The second runner extension 532 is continuous with each of the first runner extension 531 and the third runner extension 533. The second runner extension 532 is continuous with the first runner extension 531 at a predetermined angle. In an embodiment, the predetermined angle may be an obtuse angle. In the illustrated embodiment, the second runner extension 532 may extend obliquely so as to be inclined toward the lower front side and the upper rear side.

At each end in the width direction of the second runner extension 532—specifically, at the left and right ends in the illustrated embodiment—a fourth runner coupling part 554 is located.

One end of the second runner extension 532 in the extending direction—specifically, the front end in the illustrated embodiment—is continuous with the third runner extension 533. As illustrated, the other end of the second runner extension 532 in the extending direction—specifically, the rear end in the illustrated embodiment—is continuous with the first runner extension 531.

The third runner extension 533 is continuous with the second runner extension 532. The third runner extension 533 is continuous with the second runner extension 532 at a predetermined angle. In an embodiment, the predetermined angle may be an obtuse angle. In the above embodiment, the third runner extension 533 may extend in the horizontal direction.

One end of the extending direction of the third runner extension 533—specifically, the front end in the illustrated embodiment—may have each corner chamfered (tapered). Accordingly, the arc guiding effect of the third runner extension 533 may be improved. The other end of the extension direction of the third runner extension 533—specifically, the rear end in the illustrated embodiment—is continuous with the second runner extension 532.

The position of the above-mentioned one end of the third runner extension 533 may be determined according to the movement position of the movable contact terminal. That is, the third runner extension 533 may be positioned close to the movable contact terminal that has been moved to its farthest position opposite to the fixed contact terminal.

The circulation space 540 forms a passage through which residual arc, which has entered the arc extinguishing device 10 but has not been discharged to the outside, circulates and proceeds to the grid unit 400. The circulation space 540 is formed inside the arc runner 500 and allows fluid communication between the arc extinguishing device 10 and the outside.

In this case, the circulation space 540 provides fluid communication between the inside and the outside of the arc extinguishing device 10 in a direction different from that of the support frame 200 or the cover frame 300. In the illustrated embodiment, the support frame 200 or the cover frame 300 provides fluid communication between the upper side of the arc extinguishing device 10 and the outside. The circulation space 540 provides fluid communication between the rear side of the arc extinguishing device 10 and the outside.

The circulation space 540 may be defined as a space surrounded by the runner body 510 and the runner arms 520. In the illustrated embodiment, the lower side of the circulation space 540 is surrounded by the runner body 510, and the left and right sides of the circulation space 540 are surrounded by the pair of runner arms 520. The front side, rear side, and upper side of the circulation space 540 are open and in fluid communication with the outside.

A detailed description of the process in which the arc circulates through the circulation space 540 and re-enters the arc extinguishing device 10 will be provided later.

The runner coupling part 550 is a portion where the arc runner 500 is coupled to the side frame 100. The runner coupling part 550 is inserted into and coupled to the arc runner coupling part 140 of the side frame 100. Through this coupling, the arc runner 500 may be coupled to the side frame 100 and supported by the side frame 100.

The runner coupling part 550 is continuous with the runner body 510, the runner arm 520, and the runner extension 530. The runner coupling part 550 protrudes outward from each widthwise end of the runner body 510, the runner arm 520, and the runner extension 530—specifically, from the left and right ends in the illustrated embodiment.

A plurality of runner coupling parts 550 may be provided. The plurality of runner coupling parts 550 may be continuous with the runner body 510, the runner arm 520, or the runner extension 530 at different positions. In addition, the plurality of runner coupling parts 550 may be respectively coupled to the plurality of arc runner coupling parts 140.

In the illustrated embodiment, the runner coupling parts 550 include a first runner coupling part 551, a second runner coupling part 552, a third runner coupling part 553, and a fourth runner coupling part 554.

The first runner coupling part 551 is positioned at the uppermost location among the plurality of runner coupling parts 550. A pair of the first runner coupling parts 551 are provided and respectively located at the outer edges of the runner arms 520—specifically, at the left edge of the first runner arm 521 and the right edge of the second runner arm 522 in the illustrated embodiment.

The first runner coupling part 551 is positioned near one end of the extending direction of the runner arm 520—specifically, near the upper end in the illustrated embodiment. The first runner coupling part 551 is coupled to the first arc runner coupling part 141.

The second runner coupling part 552 is positioned between the first runner coupling part 551 and the third runner coupling part 553. A pair of the second runner coupling parts 552 are provided, each positioned at the outer edges of the runner arm 520. The second runner coupling part 552 is positioned near the middle portion in the extending direction of the runner arm 520. The second runner coupling part 552 is coupled to the second arc runner coupling part 142.

The third runner coupling part 553 is positioned below the second runner coupling part 552 and above the fourth runner coupling part 554. A pair of the third runner coupling parts 553 are provided, each positioned at the outer edges of the runner body 510—specifically, at the left and right edges in the illustrated embodiment. The third runner coupling part 553 is coupled to the third arc runner coupling part 143.

The fourth runner coupling part 554 is positioned below the third runner coupling part 553. A pair of the fourth runner coupling parts 554 are provided, each positioned at the outer edges in the width direction of the second runner extension 532—specifically, at the left and right edges in the illustrated embodiment. The fourth runner coupling part 554 is coupled to the fourth arc runner coupling part 144.

As not only the runner body 510 or the runner arm 520 but also the runner extension 530 is supported by the fourth runner coupling part 554, the coupling state between the arc runner 500 and the side frame 100 can be stably maintained. Accordingly, undesired oscillation of the runner extension 530 can be prevented, allowing the generated arc to be effectively guided.

In the illustrated embodiment, the first to third runner coupling parts 551, 552, and 553 extend in the vertical direction. In addition, the fourth runner coupling part 554 extends obliquely toward the lower front side and the upper rear side. At this time, the first and second runner coupling parts 551 and 552 extend to a length shorter than that of the third runner coupling part 553.

The shape and arrangement of the first to fourth runner coupling parts 551, 552, 553, and 554 may be varied according to the shape and arrangement of the first to fourth arc runner coupling parts 141, 142, 143, and 144.

The runner space 560 is a space defined by being partially surrounded by the runner extension 530. The runner space 560 is arranged to overlap with the side space 160 in the width direction, specifically, the left-right direction in the illustrated embodiment.

The runner space 560 is surrounded by the runner extension 530. In the illustrated embodiment, the upper side of the runner space 560 is surrounded by the first runner extension 531, and the front side of the runner space 560 is surrounded by the second runner extension 532. The other sides of the runner space 560—specifically, the lower side and the rear side in the illustrated embodiment—are open.

### 3. DESCRIPTION OF ARC GUIDE 600 ACCORDING TO AN EMBODIMENT OF THE PRESENT DISCLOSURE

Referring back to FIGS. 1 and 2, the arc extinguishing device 10 according to an embodiment of the present disclosure includes an arc guide 600.

The arc guide 600 according to an embodiment of the present disclosure may prevent damage to other components caused by heat or pressure generated along with the arc. In addition, the arc guide 600 allows the guided arc to be extended along the plurality of grid units 400 and thereby cooled, divided, and extinguished.

The arc guide 600 is coupled to the side frame 100. Specifically, a fastening member (not designated in the drawings) passes through the second side fastening hole 152 and a fastening hole (not designated in the drawings) of the arc guide 600, respectively, thereby coupling the arc guide 600 to the side frame 100.

The arc guide 600 is coupled to the grid unit 400. Specifically, the grid arm 420 is partially accommodated in the guide space 620 of the arc guide 600. Accordingly, damage to the grid arm 420 caused by the arc can be prevented, and the guided arc can flow along the grid body 410 and be effectively extinguished.

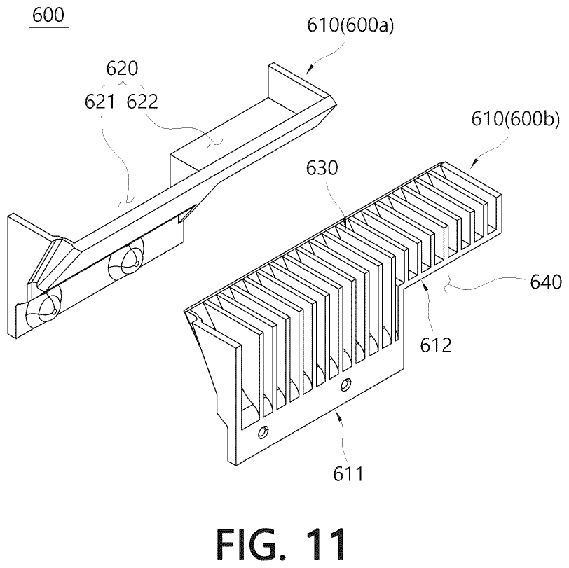

A plurality of arc guides 600 may be provided. The plurality of arc guides 600 may be respectively coupled to the plurality of side frames 100 and the plurality of grid arms 420. In the embodiment illustrated in FIG. 11, two arc guides 600 are provided, including a first arc guide 600a positioned on the left side and a second arc guide 600b positioned on the right side.

The first arc guide 600a is coupled to the first side frame 100a and the first grid arm 421. The second arc guide 600b is coupled to the second side frame 100b and the second grid arm 422.

The first arc guide 600a and the second arc guide 600b may be formed symmetrically with respect to the vertical direction. Although the arrangement positions and orientations of the first arc guide 600a and the second arc guide 600b differ slightly, their structures and functions are identical. Accordingly, the following description will collectively refer to the first arc guide 600a and the second arc guide 600b as the arc guide 600.

In the illustrated embodiment, only the guide space 620 is shown as being formed inside the first arc guide 600a, while the second arc guide 600b is shown as further including a grid support member 630. This depiction illustrates the interior of the first arc guide 600a for ease of understanding and explanation, and it will be understood that a grid support member 630 may also be provided in the guide space 620 of the first arc guide 600a to support the grid arm 420.

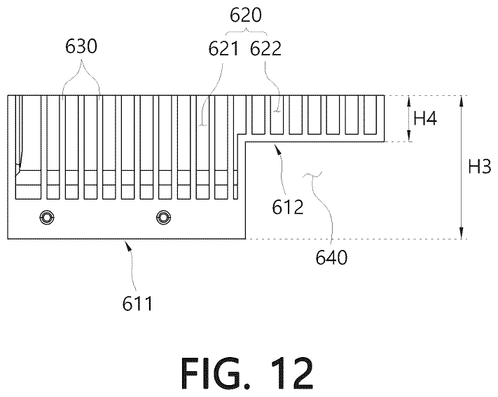

In the embodiments illustrated in FIGS. 11 to 12, the arc guide 600 includes a guide body 610, a guide space 620, a grid support member 630, and a runner receiving space 640.

The guide body 610 forms the body of the arc guide 600. The guide body 610 is a portion of the arc guide 600 that is exposed to the outside. The guide body 610 may come into direct contact with the generated arc.

In an embodiment, the guide body 610 may be formed of any material capable of generating gas due to heat or pressure. In an embodiment, the guide body 610 may be formed of an arbitrary gassing material such as nylon, melamine, PA46, PA66, polyamide resin (polyamide, PA), methyl methacrylate (MMA), polyoxymethylene (POM), or polybutylene terephthalate (PBT).

In the above embodiment, the guide body 610 may generate gas by reacting with the generated arc. Accordingly, the arc may be rapidly extinguished by the pressure generated by the gas and may proceed to the outside of the arc extinguishing device 10.

In another embodiment, the guide body 610 may be formed of any material having resistance to arcs. In an embodiment, the guide body 610 may be formed of a bulk molding compound (BMC) material.

In the above embodiment, damage to the guide body 610 caused by the generated arc may be minimized. Accordingly, damage to the arc guide 600 and the side frame 100 or the grid unit 400 coupled thereto may also be minimized.

The guide body 610 is coupled to each of the plurality of grid units 400. The guide body 610 is coupled to the grid arms 420 of the plurality of grid units 400 to cover the grid arms 420. Accordingly, the contact area between the grid arms 420 and the generated arc is minimized, thereby preventing damage to the grid arms 420.

The guide body 610 may be formed in a shape corresponding to the arrangement of the plurality of grid units 400. In the illustrated embodiment, the guide body 610 is formed to extend in the front-rear direction.

In the illustrated embodiment, the guide body 610 includes a first guide body 611 and a second guide body 612.

The first guide body 611 forms a portion of the guide body 610. The first guide body 611 is coupled to one of the first grid 400a and the second grid 400b of the grid unit 400.

In the illustrated embodiment, the first guide body 611 forms a front portion of the guide body 610. The first guide body 611 is coupled to the grid arm 420 of the first grid 400a, which is positioned toward the front side.

The first guide body 611 may have a shape corresponding to the grid arm 420 of the first grid 400a. In the illustrated embodiment, the first guide body 611 has a polygonal pillar shape that extends in the front-rear direction and has a triangular cross-section.

A first guide space 621, which is part of the guide space 620, is formed inside the first guide body 611. The grid arm 420 of the first grid 400a is accommodated in the first guide space 621.

In this case, the extension length of the first guide body 611 may be determined according to the arrangement length of the plurality of grid units 400 included in the first grid 400a. That is, the first guide body 611 may extend by a distance between the grid unit 400 positioned at the foremost side and the grid unit 400 positioned at the rearmost side among the first grid 400a.

The height of the first guide body 611—specifically, the vertical length in the illustrated embodiment—may be determined to correspond to the length of the grid arm 420 of the first grid 400a. In this case, a relationship in magnitude corresponding to the relationship in height between the first height H1 and the second height H2 may be established between the height of the first guide body 611 and the height of the second guide body 612.

That is, as shown in FIGS. 8 and 12, the third height H3, which is the height of the first guide body 611, is formed greater than the fourth height H4, which is the height of the second guide body 612. It will be understood that the above-described relationship in magnitude corresponds to the relationship in height between the grid arm 420 of the first grid 400a coupled to the first guide body 611 and the grid arm 420 of the second grid 400b coupled to the second guide body 612.

In an embodiment, the difference between the third height H3, which is the height of the first guide body 611, and the fourth height H4, which is the height of the second guide body 612, may be equal to or greater than the difference between the first height H1 and the second height H2.

The second guide body 612 forms another portion of the guide body 610. The second guide body 612 is coupled to the other one of the first grid 400a and the second grid 400b of the grid unit 400.

In the illustrated embodiment, the second guide body 612 forms a rear portion of the guide body 610. The second guide body 612 is coupled to the grid arm 420 of the second grid 400b, which is positioned at the rear side.

The second guide body 612 may have a shape corresponding to the grid arm 420 of the second grid 400b. In the illustrated embodiment, the second guide body 612 has a polygonal pillar shape that extends in the front-rear direction and has a triangular cross-section.

A second guide space 622, which is part of the guide space 620, is formed inside the second guide body 612. The grid arm 420 of the second grid 400b is accommodated in the second guide space 622.

In this case, the extension length of the second guide body 612 may be determined according to the arrangement length of the plurality of grid units 400 included in the second grid 400b. That is, the second guide body 612 may extend by a distance between the grid unit 400 positioned at the foremost side and the grid unit 400 positioned at the rearmost side among the second grid 400b.

The height of the second guide body 612—specifically, the vertical length in the illustrated embodiment—may be determined to correspond to the length of the grid arm 420 of the second grid 400b. As described above, a relationship in magnitude corresponding to the relationship in height between the first height H1 and the second height H2 may be established between the height of the second guide body 612 and the height of the first guide body 611.

In an embodiment, the difference between the fourth height H4 of the second guide body 612 and the third height H3 of the first guide body 611 may be equal to or greater than the difference between the first height H1 and the second height H2.

The guide space 620 is a space formed inside the guide body 610. A portion of the guide space 620 is surrounded by the guide body 610. Another portion of the guide body 610 is open, allowing the grid arm 420 of the grid unit 400 to be at least partially accommodated.

In the illustrated embodiment, the upper side and the outer side in the width direction of the guide space 620 are open. In addition, the front side, rear side, lower side, and inner side of the guide space 620 are surrounded by the guide body 610. The grid arm 420 accommodated in the guide space 620 may be supported by the guide body 610 and the grid support member 630.

The guide space 620 may have a shape corresponding to the shape of the guide body 610. In the illustrated embodiment, the guide space 620 is formed as a polygonal prism-shaped space having a triangular cross-section and a height in the front-rear direction.

The guide space 620 may be divided into a plurality of spaces. Some of the plurality of guide spaces 620 may be formed inside the first guide body 611 and may accommodate the grid arms 420 of the first grid 400a. Some of the remaining guide spaces 620 may be formed inside the second guide body 612 and may accommodate the grid arms 420 of the second grid 400b.

In the illustrated embodiment, the guide space 620 includes a first guide space 621 formed in the first guide body 611 and a second guide space 622 formed in the second guide body 612.

The first guide space 621 accommodates the grid arm 420 of the first grid 400a. Among the sides of the first guide space 621, the upper side and the outer side are open, so that the grid arm 420 may be inserted into or withdrawn from the first guide space 621 through the upper side and the outer side.

The first guide space 621 is in fluid communication with the second guide space 622.

The second guide space 622 accommodates the grid arm 420 of the second grid 400b. Among the sides of the second guide space 622, the upper side and the outer side are open, so that the grid arm 420 may be inserted into or withdrawn from the second guide space 622 through the upper side and the outer side.

The grid support member 630 is positioned in the guide space 620.

The grid support member 630 supports the grid arm 420 accommodated in the guide space 620. The plurality of grid arms 420 may be kept spaced apart from each other by the grid support member 630 and may be coupled to the arc guide 600.

The grid support member 630 partitions the guide space 620 into a plurality of subspaces. The grid support member 630 is formed in a shape corresponding to the guide body 610. In the illustrated embodiment, the grid support member 630 is formed in a polygonal plate shape having a triangular cross-section and a thickness in the front-rear direction.

A plurality of grid support members 630 may be provided. The plurality of grid support members 630 may be spaced apart from each other and arranged in parallel along the extending direction of the guide body 610. In the illustrated embodiment, the plurality of grid support members 630 are spaced apart from each other and arranged in parallel in the front-rear direction.

The grid support member 630 may be respectively positioned in the first guide space 621 and the second guide space 622. In this case, the grid support member 630 positioned in the first guide space 621 may be formed to have a greater height than the grid support member 630 positioned in the second guide space 622.

Accordingly, the grid arms 420 respectively accommodated in the first and second guide spaces 621 and 622 can be stably supported.

In an embodiment, the grid arm 420 may be fitted into a plurality of spaces defined by the grid support members 630. In the above embodiment, the portion of the guide space 620 that opens toward the direction in which the arc is generated (i.e., the inner sides of the pair of grid arms 420) is eliminated. Accordingly, insulation breakdown of each component of the arc extinguishing device 10—for example, the side frame 100, the grid unit 400, or the arc guide 600—can be prevented.

The runner receiving space 640 is a space formed at the lower side of the guide body 610. The runner receiving space 640 accommodates the runner extension 530 of the arc runner 500.

The runner receiving space 640 is defined by being partially surrounded by the guide body 610. In the illustrated embodiment, the front side and upper side of the runner receiving space 640 are respectively surrounded by the first guide body 611 and the second guide body 612. The rear side and lower side of the runner receiving space 640 are open, allowing the arc runner 500 to be accommodated.

The runner receiving space 640 may be formed to have a predetermined height. In the illustrated embodiment, the height of the runner receiving space 640 is defined as a fourth height H4. The difference between the third height H3 and the fourth height H4 may be defined as the height of the second guide body 612.

### 4. DESCRIPTION OF THE OPERATION OF THE ARC EXTINGUISHING DEVICE 10 ACCORDING TO AN EMBODIMENT OF THE PRESENT DISCLOSURE

The arc extinguishing device 10 according to an embodiment of the present disclosure can prevent a generated arc from proceeding toward the grid arms 420 of the grid unit 400. Accordingly, the generated arc may be transferred to another grid unit 400 along the grid body 410 of the grid unit 400. As a result, the arc can be rapidly cooled, divided, and extinguished.

In addition, the arc extinguishing device 10 according to an embodiment of the present disclosure allows an arc that has passed through the grid unit 400 but has not been discharged to the outside to circulate without stagnation and proceed again toward the grid unit 400.

Furthermore, a portion of the grid unit 400 that is located closer to the generated arc may be protected by the arc guide 600. In this case, the arc guide 600 surrounds the corresponding portion of the grid unit 400, thereby minimizing insulation breakdown.

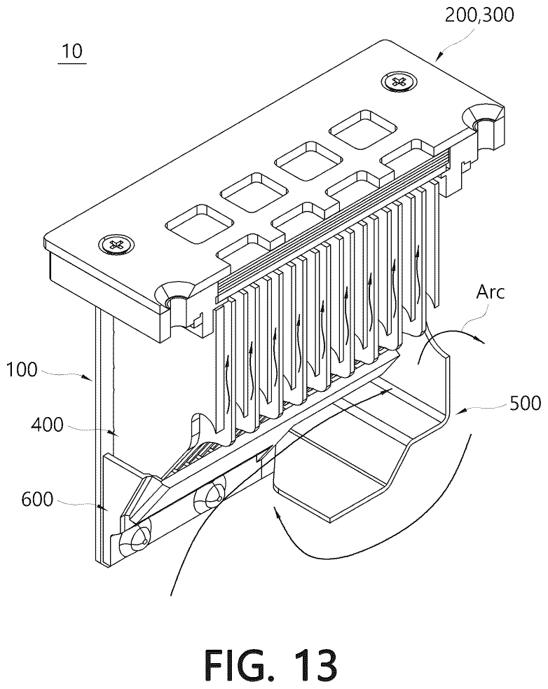

Hereinafter, with reference to FIGS. 13 and 14, a detailed description will be given of a process in which an arc generated in the arc extinguishing device 10 according to an embodiment of the present disclosure is extinguished.

Referring to FIGS. 13 and 14, the progression of an arc generated when the movable contact is separated from the fixed contact is illustrated as an example.

As the movable contact moves toward the arc runner 500, the arc is extended from the front side toward the rear side. The extended arc proceeds through the spaces between the plurality of grid units 400, is extinguished, and is then discharged to the outside after passing through the support frame 200 and the cover frame 300.

At this time, the runner extension 530 of the arc runner 500 is extended such that its end is positioned adjacent to the fully moved movable contact terminal. Accordingly, the arc extended along the movable contact terminal may be guided toward the grid unit 400 by the arc runner 500.

In addition, a portion of the arc that has passed through the grid unit 400 may collide with the plate body 222 and fail to be discharged to the outside, instead proceeding back into the interior of the arc extinguishing device 10. The returning arc may proceed back to the grid unit 400 through the circulation space 540 of the arc runner 500.

Although exemplary embodiments of the present disclosure have been described, the spirit of the present disclosure is not limited to the embodiments set forth herein. Those of ordinary skill in the art who understand the spirit of the present disclosure may easily propose other embodiments through supplement, change, removal, addition, etc. of elements within the scope of the same inventive concept, but such embodiments will also fall within the scope of the present disclosure.

| | |
|---|---|
| 10: arc extinguishing device | 100: side frame |
| 100a: first side frame | 100b: second side frame |
| 110: side body | 120: support frame coupling part |
| 130: grid coupling part | 131: first grid coupling part |
| 132: second grid coupling part | 133: third grid coupling part |
| 140: arc runner coupling part | 141: first arc runner coupling part |
| 142: second arc runner coupling part | 143: third arc runner coupling part |
| 144: fourth arc runner coupling part | 150: side fastening hole |
| 151: first side fastening hole | 152: second side fastening hole |
| 160: side space | 200: support frame |
| 210: support body | 211: plate accommodating portion |
| 212: plate support portion | 213: buffer space |
| 214: support frame coupling | 220: support plate |
| protrusion | |
| 221: plate fluid communication hole | 222: plate body |
| 230: mesh plate | 300: cover frame |
| 310: cover body | 320: cover through hole |
| 330: cover rib | 400: grid unit |
| 400a: first grid | 400b: second grid |
| 410: grid body | 420: grid arm |
| 421: first grid arm | 422: second grid arm |
| 430: arc guiding space | 440: arc extension space |
| 450: grid coupling protrusion | 451: first grid coupling protrusion |
| 452: second grid coupling protrusion | 453: third grid coupling protrusion |
| 460: frame coupling protrusion | 500: arc runner |
| 510: runner body | 520: runner arm |
| 521: first runner arm | 522: second runner arm |
| 530: runner extension | 531: first runner extension |
| 532: second runner extension | 533: third runner extension |
| 540: circulation space | 550: runner coupling part |
| 551: first runner coupling part | 552: second runner coupling part |
| 553: third runner coupling part | 554: fourth runner coupling part |
| 560: runner space | 600: arc guide |
| 600a: first arc guide | 600b: second arc guide |
| 610: guide body | 611: first guide body |
| 612: second guide body | 620: guide space |
| 621: first guide space | 622: second guide space |
| 630: grid support member | 640: runner receiving space |
| Arc: arc | H1: first height |
| H2: second height | H3: third height |
| H4: fourth height | |

1. An arc extinguishing device comprising:
a grid unit positioned to be close to a fixed contact and a movable contact to extinguish an arc generated when the fixed contact and the movable contact, which are external, are spaced apart from each other;
an arc guide configured to generate gas by reacting with the generated arc, the arc guide being coupled to the grid unit and extending in one direction; and
an arc runner positioned to be close to each of the grid unit and the arc guide, and configured to guide the generated arc toward the grid unit,
wherein the grid unit comprises:
a plurality of first grids, extending to have a predetermined height and spaced apart from each other along the one direction; and
a plurality of second grids positioned close to the plurality of first grids, extending to have a height shorter than the predetermined height, and spaced apart from each other along the one direction,
wherein the arc runner is positioned in a space defined by being surrounded by the plurality of second grids and the plurality of first grids.

2. The arc extinguishing device of claim 1,
wherein the arc guide comprises:
a guide body that at least partially surrounds the first grids and the second grids; and
a guide space formed inside the guide body and configured to at least partially accommodate the first grids and the second grids.

3. The arc extinguishing device of claim 2,
wherein the guide body comprises:
a first guide body formed to have a predetermined height and configured to at least partially surround the first grids; and
a second guide body formed to have a height shorter than the predetermined height, configured to be continuous with the first guide body and to at least partially surround the second grids.

4. The arc extinguishing device of claim 2,
wherein the guide space comprises:
a first guide space configured to at least partially accommodate the first grids; and
a second guide space configured to be in fluid communication with the first guide space and to at least partially accommodate the second grids,
wherein a height of the first guide space is greater than a height of the second guide space.

5. The arc extinguishing device of claim 2,
wherein the arc guide comprises:
a plurality of grid support members disposed in the guide space and spaced apart from each other in the one direction to divide the guide space into a plurality of subspaces.

6. The arc extinguishing device of claim 1,
wherein the arc runner comprises:
a runner body disposed to face the plurality of first grids with the plurality of second grids interposed therebetween in the one direction; and
a runner extension continuous with one end of the runner body and extending toward the first grids.

7. The arc extinguishing device of claim 6,
wherein the runner extension comprises:
a first runner extension continuous with the runner body at a predetermined angle;
a second runner extension continuous with the first runner extension at a predetermined angle; and
a third runner extension continuous with the second runner extension at a predetermined angle.

8. The arc extinguishing device of claim 7,
wherein the first runner extension extends perpendicularly from the runner body,
the second runner extension extends at an obtuse angle from the first runner extension, and
the third runner extension extends at an obtuse angle from the second runner extension,
such that the third runner extension is positioned closer to the arc guide than the first runner extension.

9. The arc extinguishing device of claim 7, wherein an edge in the width direction of an end portion of the third runner extension in an extending direction is chamfered.

10. The arc extinguishing device of claim 6,
wherein the arc runner comprises:
a runner arm that is continuous with the other end of the runner body and extends outward.

11. The arc extinguishing device of claim 10,
wherein the runner arm is provided in plurality, the plurality of runner arms being spaced apart from each other in a width direction of the runner body, and
wherein the arc runner comprises:
a circulation space that is defined by being surrounded by the runner body and the plurality of runner arms, is open, and allows a space in which the plurality of grid units are located, to be in fluid communication with the outside.

12. The arc extinguishing device of claim 10,
further comprising a side frame coupled to each of the arc runner and the arc guide,
wherein the arc runner comprises:
a runner coupling part that protrudes outward from an end in a width direction and is coupled to the side frame.

13. The arc extinguishing device of claim 12,
wherein the runner coupling part comprises:
a first runner coupling part and a second runner coupling part protruding outward from an end in a width direction of the runner arm;
a third runner coupling part protruding outward from an end in a width direction of the runner body; and
a fourth runner coupling part protruding outward from an end in a width direction of the runner extension.

14. The arc extinguishing device of claim 12,
wherein the side frame comprises:
an arc runner coupling part formed to penetrate in a thickness direction of the side frame and coupled to the runner coupling part.

15. The arc extinguishing device of claim 1, wherein the arc runner extends to one of the plurality of second grids that is positioned closest to the first grid.
